(19) United States
(12) Patent Application Publication
(10) Pub. No.: US 2022/0250462 A1
(43) Pub. Date: Aug. 11, 2022

(54) HYBRID TRANSMISSION UNIT HAVING PLANETARY WHEEL SETS FOR IMPLEMENTING TWO SERIAL AND FOUR PARALLEL MODES, AND MOTOR VEHICLE

(71) Applicant: SCHAEFFLER TECHNOLOGIES AG & CO. KG, Herzogenaurach (DE)

(72) Inventors: Laurent Bayoux, Strasbourg (FR); Matthieu Rihn, Kuttolsheim (FR)

(73) Assignee: SCHAEFFLER TECHNOLOGIES AG & CO. KG, Herzogenaurach (DE)

(21) Appl. No.: 17/611,142

(22) PCT Filed: May 11, 2020
(86) PCT No.: PCT/DE2020/100393

§ 371 Date: Nov. 13, 2021

(30) Foreign Application Priority Data
May 13, 2019 (DE) 10 2019 112 402.6

(51) Int. Cl. B60K 6/547; B60K 6/365; B60K 6/38; F16H 61/682

(52) U.S. Cl. CPC B60K 6/547; B60K 6/365; B60K 6/38; F16H 2200/0086; B60Y 2200/92; F16H 2200/006; F16H 61/682

(57) ABSTRACT

A transmission unit for a hybrid motor vehicle, includes an input shaft that can be connected to an internal combustion engine, a planetary gearing, which can be coupled to the input shaft, the planetary gearing having a first planetary wheel set and a second planetary wheel set, a first electric machine the rotor of which is rotationally fixedly coupled to the input shaft, a second electric machine which is coupled with a component part of the planetary gearing, and no more than four switching devices, each of which forms a brake or a clutch, and each can be moved between an activated position and a deactivated position. The switching devices are used for switching various transmission ratios acting between the input shaft and an output shaft and/or between the second electric machine and the output shaft. The no more than four switching devices are configured to implement four different transmission ratios in a drive state of the internal combustion engine, and two different transmission ratios in a drive state of the second electric machine, thereby implementing a serial operation as a result of their activated and deactivated positions. The invention disclosure also relates to a motor vehicle comprising said transmission unit.

### CROSS-REFERENCE TO RELATED APPLICATIONS

This application is the U.S. National Phase of PCT Appln. No. PCT/DE2020/100393 filed May 11, 2020, which claims priority to DE 102019112402.6 filed May 13, 2019, the entire disclosures of which are incorporated by reference herein.

### TECHNICAL FIELD

The disclosure relates to a transmission unit (also referred to as a (dedicated) hybrid transmission) for a hybrid motor vehicle, with an input shaft that can be connected to an internal combustion engine, a planetary gearing that can be coupled to the input shaft, the planetary gearing having a first planetary wheel set and a second planetary wheel set, a first electric machine, wherein a rotor of the first electric machine is non-rotatably attached to the input shaft, a second electric machine coupled to a component part of the planetary gearing, and no more than four switching devices, each of which forms a brake or a clutch, and each can be moved between an activated position and a deactivated position, wherein the switching devices are used for switching various transmission ratios acting between the input shaft and an output shaft and/or between the second electric machine and the output shaft.

### BACKGROUND

Generic transmission units are known from CN 109177716 A, for example.

Consequently, systems which have a transmission, two electric machines (a first electric machine used predominantly as a generator and a second electric machine used as a motor) and a clutch device are already known. However, in these designs known from the prior art, it has been found to be disadvantageous that the existing switchable gears specified by the transmission are all used for both the internal combustion engine and for the driving electric motor. These gears are thus used identically for the internal combustion engine and the second electric machine. However, for a further optimization of the efficiency of torque transmission, it has been found that as few gears as possible are sufficient for driving the motor vehicle using the second electric machine. At the same time, for driving the motor vehicle using the internal combustion engine, it is advantageous if the internal combustion engine can be coupled to the drive wheels via as many different gears as possible.

### SUMMARY

Therefore, the object of the present disclosure is to eliminate the disadvantages known from the prior art and provide a modular transmission unit which enables an improved efficiency of the drive train.

This is achieved according to the disclosure by the fact that the no more than four switching devices are configured to implement four different transmission ratios (between the input shaft and the output shaft) in a drive state of the internal combustion engine, and two different transmission ratios (between the second electric machine and the output shaft) in a (pure) drive state of the second electric machine, thereby implementing a serial operation as a result of their activated and deactivated positions. As a result, four modes/transmission ratios are implemented in a parallel operation (first drive state), in which the internal combustion engine alone or together with the second electric machine drives the drive wheels of the motor vehicle, and two serial modes/transmission ratios are implemented in a serial operation (second drive state), in which the internal combustion engine does not drive the drive wheels of the motor vehicle through a direct coupling via the planetary gearing, but in which the internal combustion engine drives the first electric machine operating as a generator, wherein the electrical energy generated by the first electric machine is used to drive the second electric machine, which in turn drives the drive wheels of the motor vehicle.

As a result, a transmission unit is provided that is particularly simple in design and can be compactly inserted as a module in the drive train. At the same time, the efficiency is improved by the fact that different numbers of gears can be switched depending on the drive state.

Further advantageous embodiments are explained in more detail below.

The advantageous arrangements of the switching devices explained below relate to their operative connectivity with the corresponding component parts of the planetary gearing used for acting between the input shaft and the output shaft, wherein the first electric machine is always coupled to the input shaft and the second electric machine is also coupled to a component of the planetary gearing between the input shaft and the output shaft.

Accordingly, it is advantageous if a first switching device and/or a second switching device (of no more than four switching devices) are/is designed as a clutch. This allows the internal combustion engine to be decoupled from or coupled to the planetary gearing in a skillful manner.

It has also been found to be useful if the first switching device is designed as a clutch that is operatively installed between the input shaft and a first sun gear which meshes with the first planetary wheel set, so that, in the activated position of the first switching device, the input shaft is rotationally connected with the first sun gear (i.e., a drive power can be transmitted between the input shaft and the first sun gear) and, in the deactivated position of the first switching device, the input is decoupled from the first sun gear (i.e., no drive power can be transmitted between the input shaft and the first sun gear).

With regard to the second switching device, it is particularly expedient if it is designed as a clutch that is operatively installed between the input shaft and a (first) planetary carrier of the first planetary wheel set so that, in the activated position of the second switching device, the input shaft is rotationally connected to the (first) planetary carrier of the first planetary wheel set (i.e., a drive power can be transmitted between the input shaft and the first planetary carrier) and, in the deactivated position of the second switching device, the input shaft is decoupled from the (first) planetary carrier of the first planetary wheel set (i.e., no drive power can be transmitted between the input shaft and the first planetary carrier).

In addition, it is expedient if a third switching device and/or a fourth switching device (of the no more than four switching devices) are/is designed as a brake. This means that the other transmission ratios/gears can also be switched easily.

It is advantageous if the third switching device is designed as a brake acting on a second sun gear, wherein the second sun gear meshes with a second planetary wheel set of the planetary gearing, so that, in the activated position of the third switching device, the second sun gear is blocked from rotation and, in the deactivated position of the third switching device, free rotation of the second sun gear is enabled.

For the fourth switching device, it is also useful if this is designed as a brake acting on the first sun gear, so that, in the activated position of the fourth switching device, the first sun gear is blocked from rotating and, in the deactivated position of the fourth switching device, a free rotation of the first sun gear is enabled.

Thus, the not more than four switching devices are particularly preferably configured to implement four different transmission ratios in a drive state of the internal combustion engine and two different transmission ratios in a drive state of the second electric machine. Furthermore, it is advantageous if a stationary state of charge is formed via these no more than four switching devices in that the internal combustion engine supplies drive power to the first electric machine, which then acts as a generator. It is also advantageous if the no more than four switching devices also enable reversing in an electric mode or an eCVT mode (electric continuously variable transmission).

On the part of the structure of the planetary gearing, it has also been found to be expedient if a first ring gear that meshes with the first planetary wheel set is permanently non-rotatably coupled to a (second) planetary carrier of the second planetary wheel set and/or the (first) planetary carrier of the first planetary wheel set is non-rotatably connected to a second ring gear that meshes with the second planetary wheel set.

If a rotor-fixed drive shaft of the second electric machine is rotationally coupled to the (first) planetary carrier of the first planetary wheel set (preferably via a gear stage), the second electric machine is connected to the planetary gearing in a particularly simple and com-pact manner. The drive shaft is preferably arranged parallel to a central axis of rotation of the transmission unit (axis of rotation of the input shaft/the sun gears/the planetary carrier).

The disclosure also relates to a motor vehicle having an internal combustion engine, such as a gasoline or diesel engine, and a transmission unit according to the disclosure according to at least one of the embodiments described above that is connected or connectable with its input shaft to a motor output shaft of the internal combustion engine.

In other words, according to the disclosure, a dedicated hybrid transmission with a planetary wheel set with two serial modes and four parallel modes can thus be implemented. The hybrid transmission indicated has (no more than) four clutches, two planetary wheel sets and two electric machines for implementing two gears of a second electric machine and four gears of the internal combustion engine.

### BRIEF DESCRIPTION OF THE DRAWINGS

In the following, the disclosure is now explained in more detail with reference to figures.

In the figures:

FIG. 1 shows a schematic sectional representation of a transmission unit according to the disclosure, installed in a partially illustrated drive train of a motor vehicle, according to a preferred exemplary embodiment,

FIG. 2 shows a diagram to illustrate the gears that can be switched by the transmission unit of FIG. 1, and

FIG. 3 shows a schematic representation of a motor vehicle together with the transmission unit according to the disclosure according to FIG. 1.

The figures are only schematic in nature and serve only for understanding the disclosure. The same elements are provided with the same reference symbols.

### DETAILED DESCRIPTION

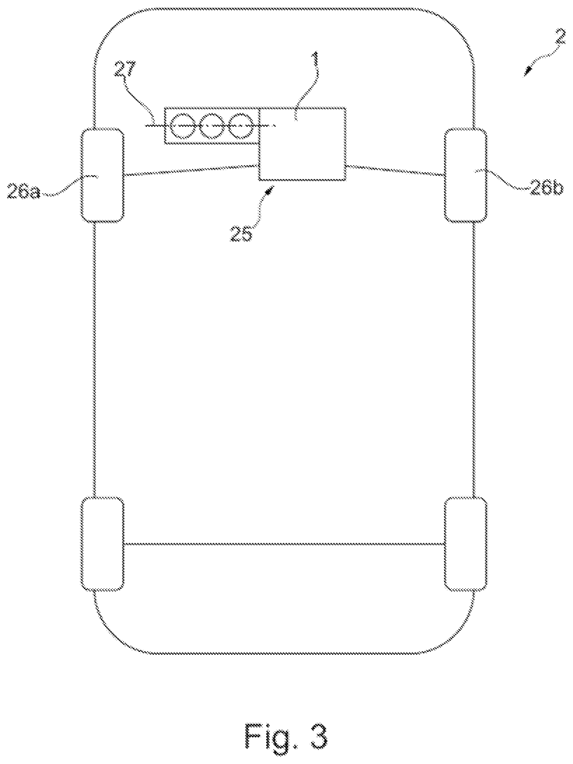

FIG. 1 clearly shows a drive train 25 of a motor vehicle 2 with a transmission unit 1 according to the disclosure. The transmission unit 1 installed in this drive train 25 is implemented as a hybrid transmission and, alternatively, also designated as such. A preferred position of the transmission unit 1 and the drive train 25 is shown in FIG. 3 in a schematically represented motor vehicle 2 (here a car). It can be seen here that the transmission unit 1 with the drive train 25 is operatively installed on a front axle of the motor vehicle 2.

Returning to FIG. 1, it can be seen that the transmission unit 1 forms an input in the form of an input shaft 4, which is or can be coupled to an internal combustion engine 3, and forms an output in the form of an output shaft 16 which is drivingly coupled or can be coupled to a drive output, for example to two driven wheels 26a, 26b of the motor vehicle 2 according to FIG. 3. This is a front-transverse arrangement of the internal combustion engine 3 together with the transmission unit 1. A rotational axis 27, shown schematically in FIG. 1, of a motor output shaft 24 (crankshaft) of the internal combustion engine 3 which corresponds to a central axis of rotation 27 of the transmission unit 1 is consequently oriented transversely to be approximately perpendicular to the longitudinal axis of the vehicle. The disclosure can of course also be applied in a longitudinal configuration (motor-transmission at the front, transmission shaft to the rear driven wheels).

According to the design as a hybrid transmission, the transmission unit 1 has a two-stage planetary gearing 5 and two electric machines 8, 11. The basic structure of the transmission unit 1 can be seen particularly well in FIG. 1. Accordingly, the planetary wheel set 5 has a first planetary wheel set 6, which forms the first gear stage of the planetary gearing 5, and a second planetary wheel set 7, which forms the second gear stage of the planetary gearing 5. The first planetary wheel set 6/the individual (first) planetary wheels 28 of the first planetary wheel set 6 mesh with a first sun gear 17 on the one hand and a first ring gear 20 on the other. The first planetary wheel set 6 is rotatably arranged with its individual (first) planetary wheels 28 on a first planetary carrier 18.

It can be seen that the first planetary carrier 18 simultaneously forms a (second) ring gear 22 of the second gear stage of the planetary gearing 5. The first planetary carrier 18 is thus non-rotatably connected to the second ring gear 22, which second ring gear 22 in turn meshes with the second planetary wheel set 7/the (second) planetary wheels 29 of the second planetary wheel set 7. The individual (second) planetary wheels 29 of the second planetary wheel set 7 also mesh with a second sun gear 19. Furthermore, the first ring gear 20 is non-rotatably connected to a second planetary carrier 21 which rotatably supports the second planetary wheels 29. The second planetary carrier 21 and the first ring gear 20 are each directly non-rotatably connected to the output shaft 16 of the transmission unit 1/the planetary gearing 5.

A first electric machine 8 typically has a stator 30 and a rotor 9 that is rotatably mounted relative to the stator 30. The rotor 9 is rotatably received within the stator 30. The rotor 9 is directly non-rotatably attached on an input shaft 4 of the first electric machine 8.

A second electric machine 11 typically also has a stator 31 and a rotor 32 that is rotatably mounted relative to the stator 31. The rotor 32 of the second electric machine 11 is rotatably received within the stator 31 of the second electric machine 11. The rotor 32 is non-rotatably attached on a drive shaft 23 of the second electric machine 11. The drive shaft 23 is arranged with its rotational axis parallel, i.e., radially at a distance, from the central rotational axis 27 of the transmission unit 1. Furthermore, the drive shaft 23 is rotationally coupled via a gear stage 33 to a component part 10 of the planetary gearing 5 in the form of the first planet carrier 18 and the second ring gear 22.

In FIG. 1, it can also be seen that, in principle, a torsional vibration damper 34 can be integrated into the drive train 25 on the part of the internal combustion engine 3. The torsional vibration damper 34 is arranged here between the output shaft 16 of the internal combustion engine 3 and the input shaft 4 of the transmission unit 1. The torsional vibration damper 34 can in principle be viewed as a component part of the transmission unit 1 or as a separate component thereof.

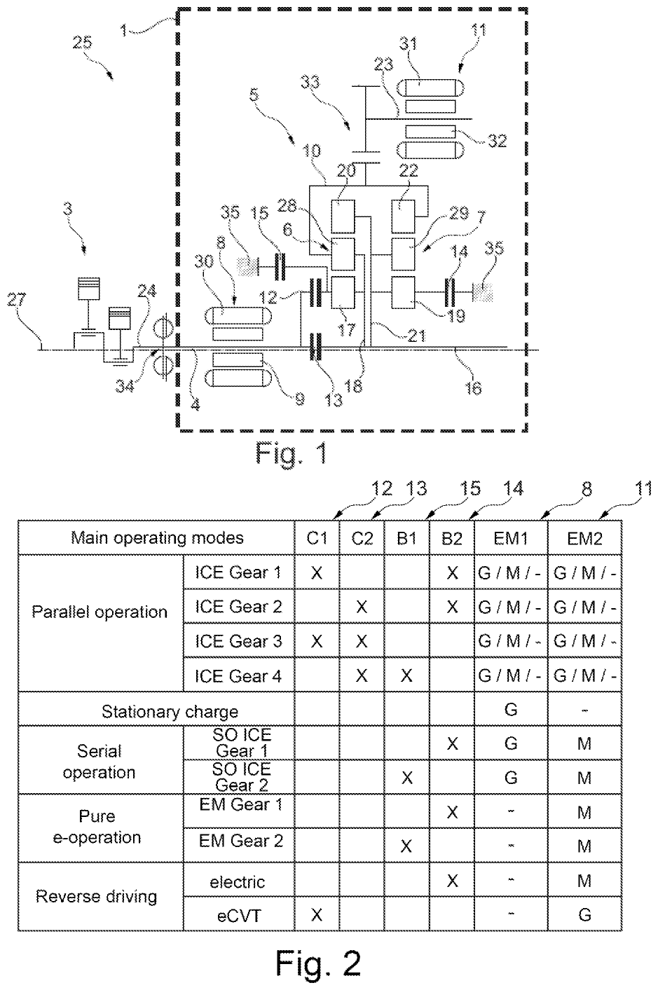

According to the disclosure, in FIG. 1, exactly, i.e., no more and no less than, four switching devices 12, 13, 14, 15 are integrated into the transmission unit 1 in order to use their deactivated and activated positions to implement the individual transmission ratios/gears, as shown in FIG. 2.

A first switching device 12 is implemented as a clutch. The first switching device 12 is operatively installed between the input shaft 4 and the first sun gear 17. By designing the first switching device 12 as a clutch, when the motor vehicle 2 is in operation, the input shaft 4, and thus the motor output shaft 24, is non-rotatably coupled to the first sun gear 17 in an activated position of the first switching device 12 and rotationally decoupled from the first sun gear 17, i.e., freely rotatable relative thereto, in a deactivated position of the first switching device 12. The activated position of the first switching device 12 is thus a closed clutch position, whereas the deactivated position is an open clutch position.

A second switching device 13 is also implemented as a clutch. The second switching device 13 is operatively installed between the input shaft 4 and the first planetary carrier 18. Accordingly, when the motor vehicle 2 is in operation, the input shaft 4, and thus the motor output shaft 24, is non-rotatably connected to the first planetary carrier 18 in the activated position of the second switching device 13 and rotatably decoupled from the first planetary carrier 18 i.e., arranged freely rotatable relative thereto, in a deactivated position of the second switching device 13. Thus, the activated position of the second switching device 13 is a closed clutch position and the deactivated position of the second switching device 13 is an open clutch position.

The third switching device 14 and the fourth switching device 15 are each implemented as brakes. The third switching device 14 is the brake that interacts with the second sun gear 19. The third switching device 14 is thus able to brake/hold the second sun gear 19 in relation to a region 35 of the motor vehicle 2 that is fixed to the vehicle frame. In an activated position of the third switching device 14, the third switching device 14 acts on the second sun gear 19 in such a way that the latter is blocked in its rotation relative to the area 35 of the motor vehicle 2 fixed to the vehicle frame; in a deactivated position of the third switching device 14, the third switching device 14 is arranged in such a way that it enables/allows free rotation of the second sun gear 19 relative to the region 35.

The fourth switching device 15 acts substantially in the same way as the third switching device 14. However, this does not act on the second sun gear 19, but on the first sun gear 17.

In connection with FIG. 2, the individual operating/drive states of the drive train 25 are illustrated. In a first drive state (parallel operation), either only the internal combustion engine 3 or the internal combustion engine 3 supported by one or both electric machines 8, 11, has a driving effect on the driven wheels 26a, 26b. In the four different gears/gear ratios, which can be implemented by means of the four switching devices 12, 13, 14, 15, the first electric machine 8 (“EM1”) and the second electric machine 11 (“EM2”) are optionally available as a generator “G” or as a drive motor “M” in a working or inactive/idling state.

In the first drive state for implementing a first gear (“ICE Gear 1”) the first switching device 12 (“C1”) and the third switching device 14 (“B2”) are in their activated position, while the second switching device 13 (“C2”) and the fourth switching device 15 (“B1”) are in their deactivated positions. Accordingly, a first transmission ratio is implemented via the input shaft 4, the first sun gear 17, the first planetary wheel set 6, the first planetary carrier 18, the second ring gear 22, the second planetary wheel set 7, the second planetary carrier 21 towards the output shaft 16.

In the first drive state for implementing a second gear (“ICE Gear 2”) the second switching device 13 and the third switching device 14 are in their activated position, while the first switching device 12 and the fourth switching device 15 are switched in their deactivated position. In this case, the drive power is transmitted from the input shaft 4 via the first planetary carrier 18, the second ring gear 22, the second planetary wheel set 7 to the output shaft 16.

In the first drive state for implementing a third gear (“ICE Gear 3”) the first switching device 12 and the second switching device 13 are in their activated position and the third switching device 14 and the fourth switching device 15 are in their deactivated position. The drive power is transmitted from the input shaft 4 to both the first sun gear 17 and the first planetary carrier 18. From there, the drive power is transmitted via the first planetary wheel set 6 and the first ring gear 20 to the output shaft 16.

To implement a fourth gear (“ICE Gear 4”) the first switching device 12 and the third switching device 14 are in their deactivated position and the second switching device 13 and the fourth switching device 15 are in their activated position. Thus, drive power is transmitted from the input shaft 4 via the first planetary carrier 18, the first planetary wheel set 6 and the first ring gear 20 to the output shaft 16.

In a second drive state (“serial operation”) according to FIG. 2, the first electric machine 8 permanently acts as a generator and the second electric machine 11 permanently acts as a drive motor. The first electric machine 8 consequently serves to convert the mechanical energy generated by the internal combustion engine 3 into electrical energy, which is then supplied to the second electric machine 11 as drive energy/power, for example with intermediate storage in a battery. In accordance with the implementation of a serial operation, the first and second switching devices 12, 13 are thus permanently opened/deactivated. Overall, no more than two gears/transmission ratios can be selected in this second drive state.

A first gear of the second drive state (“SO ICE Gear 1”) is implemented by activating the third switching device 14 (while the fourth switching device 15 is deactivated). Accordingly, in this first gear of the second drive state, a drive power of the second electric machine 11 is transmitted from the drive shaft 23 via the second ring gear 22, the second planetary wheel set 7 and the second planetary carrier 21 to the output shaft 16.

A second gear of the second drive state (“SO ICE Gear 2”) is implemented by activating the fourth switching device 15 (while the third switching device 14 is deactivated).

Accordingly, in this second gear of the second drive state, a drive power of the second electric machine 11 is transmitted from the drive shaft 23 via the first planetary carrier 18, the first planetary wheels 28 and the second ring gear 22 to the output shaft 16.

In a third drive state (“pure e-operation”) the internal combustion engine 3 is switched off compared to the second drive state. Consequently, the first electric machine 8 is also inactive. The drive power is supplied exclusively by means of energy previously stored by the second electric machine 11. The two gears of this third drive state (“EM Gear 1” and “EM Gear 2”) are implemented in a similar way to the gears of the second drive state.

In addition, a stationary state of charge (fourth operating state) of the drive train 25 can be implemented. Here, with the internal combustion engine 3 running, drive power from the internal combustion engine 3 is supplied to the first electric machine 8 operating as a generator and converted there into electrical energy for storage in a battery. In this stationary state of charge, all four switching devices 12, 13, 14, 15 are in their deactivated position.

Furthermore, as can be seen from the diagram in FIG. 2, these four switching devices 12, 13, 14, 15 can also be used to implement two reverse gears/reverse driving states (for a fifth operating state of the drive train 25). This is possible either purely electrically or by means of an electric continuously variable transmission (eCVT). The first electric machine 8 is always inactive. In the purely electric reversing (“electric”), the third switching device 14 is switched in its activated position, while the first, second and fourth switching devices 12, 13, 15 are arranged in their deactivated position. The second electric machine 11 serves as a drive motor. In the eCVT state (“ecvt”), the first switching device 12 is activated and the remaining second to fourth switching devices 13, 14, 15 are deactivated. The second electric machine 11 then acts as a generator.

In principle, boosting and energy recuperation are possible in all gears. Load point displacement of the internal combustion engine 3 is also possible in all gears of the internal combustion engine 3.

In other words, according to the disclosure, a transmission concept 1 (with four switching devices 12, 13, 14, 15/clutches, two different planet wheels 28, 29 and two electric machines 8, 11) is proposed which allows two gears for the electric motor 11 and four gears for the internal combustion engine 3.

### LIST OF REFERENCE SYMBOLS

1 Transmission unit
2 Motor vehicle
3 Internal combustion engine
4 Input shaft
5 Planetary gearing
6 First planetary wheel set
7 Second planetary wheel set
8 First electric machine
9 Rotor of the first electric machine
10 Component part
11 Second electric machine
12 First switching device
13 Second switching device
14 Third switching device
15 Fourth switching device
16 Output shaft
17 First sun gear
18 First planetary carrier
19 Second sun gear
20 First ring gear
21 First planetary carrier
22 Second ring gear
23 Drive shaft
24 Motor output shaft
25 Drive train
26a First driven wheel
26b Second driven wheel
27 Axis of rotation
28 First planetary wheel
29 Second planetary wheel
30 Stator of the first electric machine
31 Stator of the second electric machine
32 Rotor of the second electric machine
33 Gear stage
34 Torsional vibration damper
35 Region fixed to the vehicle frame

1.-10. (canceled)

11. A transmission unit for a hybrid motor vehicle, comprising:
an input shaft for connecting to an internal combustion engine;
a planetary gearing coupled to the input shaft and including a first planetary wheel set and a second planetary wheel set;
a first electric machine including a rotor that is rotationally fixedly coupled to the input shaft;
a second electric machine coupled with a component part of the planetary gearing;
an output shaft for coupling to a drive output; and
four switching devices for switching various transmission ratios acting between the input shaft and an output shaft and/or between the second electric machine and the output shaft.

12. The transmission unit of claim 11, wherein each of the four switching devices is configured as a brake or a clutch, such that each of the four switching devices can be moved between an activated position and a deactivated position.

13. The transmission unit of claim 12, wherein the four switching devices are configured to implement four different transmission ratios in a drive state of the internal combustion engine and to implement two different transmission ratios in a drive state of the second electric machine, such that the four switching devices provide a serial operation of the internal combustion engine and the second electric machine as a result of the activated and deactivated positions.

14. The transmission unit of claim 12, wherein a first switching device or a second switching device comprising the four switching devices is configured as a clutch.

15. The transmission unit of claim 14, wherein the first switching device is operatively installed between the input shaft and a first sun gear that meshes with the first planetary wheel set, such that the activated position causes the first switching device to transmit a drive power between the input shaft and the first sun gear.

16. The transmission unit of claim 14, wherein the second switching device is operatively installed between the input shaft and a planet carrier of the first planetary wheel set, such that the activated position causes the second switching device to transmit a drive power between the input shaft and the planet carrier of the first planetary wheel set.

17. The transmission unit of claim 12, wherein a third switching device or a fourth switching device comprising the four switching devices is configured as a brake.

18. The transmission unit of claim 17, wherein the third switching device is configured to act as a brake on a second sun gear that is meshed with the second planetary wheel set of the planetary gearing, such that the activated position causes the third switching device to block rotation of the second sun gear.

19. The transmission unit of claim 18, wherein the deactivated position causes the third switching device to enable free rotation of the second sun gear.

20. The transmission unit of claim 17, wherein the fourth switching device is configured to act as a brake on the first sun gear, such that the activated position causes the fourth switching device to block rotation of the first sun gear.

21. The transmission unit of claim 20, wherein the deactivated position causes the fourth switching device to enable free rotation of the first sun gear.

22. The transmission unit of claim 21, wherein a first ring gear that is meshed with the first planetary wheel set is non-rotatably coupled to a planetary carrier of the second planetary wheel set.

23. The transmission unit of claim 22, wherein the planetary carrier of the first planetary wheel set is non-rotatably coupled to a second ring gear that is meshed with the second planetary wheel set.

24. The transmission unit of claim 23, wherein the second electric machine includes a rotor-fixed drive shaft that is rotatably coupled to the planetary carrier of the first planetary wheel set.

25. A hybrid motor vehicle including an internal combustion engine and having a transmission unit, the transmission unit comprising:
an input shaft that is connectable to a motor output shaft of the internal combustion engine;
a planetary gearing that is coupled to the input shaft;
a first electric machine that is fixedly coupled to the input shaft;
a second electric machine that is coupled with the planetary gearing;
an output shaft that is coupled to one or more driven wheels; and
four switching devices for switching various transmission ratios.

26. The transmission unit of claim 25, wherein each of the four switching devices is configured to operate as a brake or a clutch, such that each of the four switching devices can be moved between an activated position and a deactivated position.

27. The transmission unit of claim 25, wherein four switching devices are configured to provide various transmission ratios acting between the input shaft and an output shaft and/or between the second electric machine and the output shaft.

28. A method for a transmission unit for a hybrid motor vehicle, comprising:
connecting an input shaft to an internal combustion engine;
coupling a planetary gearing to the input shaft;
fixating a first electric machine to the input shaft;
coupling a second electric machine with the planetary gearing;
coupling an output shaft to one or more driven wheels; and
configuring four switching devices for switching various transmission ratios.

29. The method of claim 28, wherein configuring the four switching devices includes configuring the four switching devices as a brake or a clutch, such that each of the four switching devices can be moved between an activated position and a deactivated position.

30. The method of claim 28, wherein configuring the four switching devices includes configuring the four switching devices to act between the input shaft and an output shaft and/or between the second electric machine and the output shaft.
